(19) United States
(12) Patent Application Publication
(10) Pub. No.: US 2016/0331078 A1
(43) Pub. Date: Nov. 17, 2016

(54) SOLE RESISTANT TO PERFORATION AND METHOD OF MANUFACTURING THEREOF

(71) Applicant: VIBRAM S.P.A., Albizzate(Varese) (IT)

(72) Inventor: Claudio CONCHIERI, Albizzate (Varese) (IT)

(21) Appl. No.: 15/109,780

(22) PCT Filed: Dec. 30, 2014
(86) PCT No.: PCT/IB2014/067411

§ 371 Date: Jul. 5, 2016

(30) Foreign Application Priority Data
Jan. 3, 2014 (IT) VR2014A000001

(51) Int. Cl. A43B 13/18; A43B 13/22; B29D 35/14; A43B 13/14; B29D 35/00; A43B 13/12; A43B 13/04

(52) U.S. Cl. CPC A43B 13/187; A43B 13/181; A43B 13/12; A43B 13/22; A43B 13/04; A43B 13/141; B29D 35/0054; B29D 35/142; B29D 35/148; B29K 2021/00

(57) ABSTRACT

A sole for footwear having at least one outer sole in elastomeric material having a tread and a perimeter edge rising from such tread. The tread includes an outer face. The sole also includes at least one layer of textile fiber material resistant to perforation, having a lower face, facing the outer face of the tread, and an upper face facing the perimeter edge.

At least one outer sole and at least one layer of the textile fiber material resistant to perforation are engaged by molding the at least one outer sole on or around the at least one layer of textile fiber material resistant to perforation.

### TECHNICAL FIELD

The present disclosure regards a footwear sole that is resistant to perforation. The present disclosure also regards a method of manufacturing one such sole for footwear.

### BACKGROUND

In the footwear industry, more particularly in the field of footwear of so-called “safety” type, the problem of manufacturing footwear that is comfortable but at the same time safe for field operators is widespread.

Generally, the more comfortable a shoe, the more its sole—in addition to being light—can be adapted to the position assumed each time by the foot of the operator who wears it.

The more the shoe is able to protect the foot from possible risks, the safer the shoe; such risks include in particular sole perforation, for example by nails, screws or pointed objects of various type that can inadvertently be left on the ground, especially in places such as work yards, warehouses, etcetera.

At the state of the art, there is footwear on the market so-called “safety” footwear, which at the sole have a layer made of metallic material, e.g. a steel plate, intended to prevent, in case of penetration by a pointed object, the contact of the penetrated object with the foot.

However, one such steel plate, in addition to making the sole of the shoe extremely rigid and heavier, is provided for covering only about 85% of the sole, such that the remaining 15% of the sole and, hence, of the foot wearing it, is still exposed to the risk of perforation by pointed objects.

Another problem of the safety footwear of known type is that in order to obtain the requested perforation resistant characteristics, the structural form of the shoe is relatively complex, comprising multiple elements that must be assembled together.

It is necessary to assemble the sole, of normal type, with multiple anti-perforation layers, e.g. by means of gluing and then applying the upper.

Alternatively, an insole suitably made with anti-perforation materials is introduced inside the already-formed shoe; hence a step of manufacturing such insoles must be provided along with the relative step of introduction and sewing on the upper, which in turn must be made so as to provide for the space for the anti-perforation insole.

There is therefore the need to obtain a sole for footwear which, while remaining of conventional weight and size, in the field of safety footwear, is comfortable and resistant to perforation.

There is also the need to simplify the manufacturing of the safety footwear, rendering it similar or equivalent to the manufacturing of the footwear of normal type.

### SUMMARY

Hence, the present disclosure improves the state of the art in the field of soles for footwear.

The present disclosure further provides a sole for footwear which is more comfortable than the soles for conventional footwear.

Still the present disclosure provides a sole for footwear which is more resistant to perforation with respect to the soles for conventional footwear.

The present disclosure further provides a sole for footwear, which is easy to manufacture at competitive costs.

The present disclosure provides a sole for safety footwear already comprising the necessary layers of anti-perforation material, thus simplifying the manufacturing of the same safety footwear, i.e. entirely similar to the manufacturing of footwear of normal type.

Not least the present disclosure provides a method of manufacturing a sole for footwear that is easy and quick to implement.

According to a first aspect of the present disclosure, a sole for footwear is provided that is resistant to perforation, the sole having at least one outer sole in elastomeric material comprising a tread and a perimeter edge rising from said tread, said tread comprising an outer face; and at least one layer of textile fiber material resistant to perforation having a lower face facing said outer face of said tread, and an upper face facing said perimeter edge; and wherein said at least one outer sole and said at least one layer of said textile fiber material resistant to perforation are engaged by molding said at least one outer sole on or around said at least one layer of said textile fiber material resistant to perforation.

According to a further aspect of the present disclosure, a method is provided of manufacturing a sole for footwear including the following steps: arranging at least one mold adapted to molding the outer sole; introducing into the mold at least one certain quantity of uncured elastomeric material for the outer sole; arranging the quantity of uncured elastomeric material at least one layer of textile fiber material resistant to perforation; closing the mold; and applying to the mold a sufficient pressure and a temperature to cause the molding of the uncured elastomeric material on or around the at least one layer.

### BRIEF DESCRIPTION OF THE DRAWINGS

Other characteristics and advantages of the present disclosure will be clear from the description of one embodiment of a sole for footwear, illustrated as a merely non-limiting example in the enclosed drawings, wherein:

FIG. 1 is a plan view of a sole for footwear according to the disclosure;

FIG. 2 shows a cross section view of the footwear sole of FIG. 1, taken along the section line II-II;

FIG. 3 illustrates a cross section view of a variant of the footwear sole of FIG. 1, taken along the section line II-II;

FIG. 4 is a cross section view of another variant of the footwear sole of FIG. 1, taken along the section line II-II; and

FIG. 5 shows a cross section view of a further variant of the footwear sole of FIG. 1, taken along the section line II-II.

### DETAILED DESCRIPTION OF THE DRAWINGS

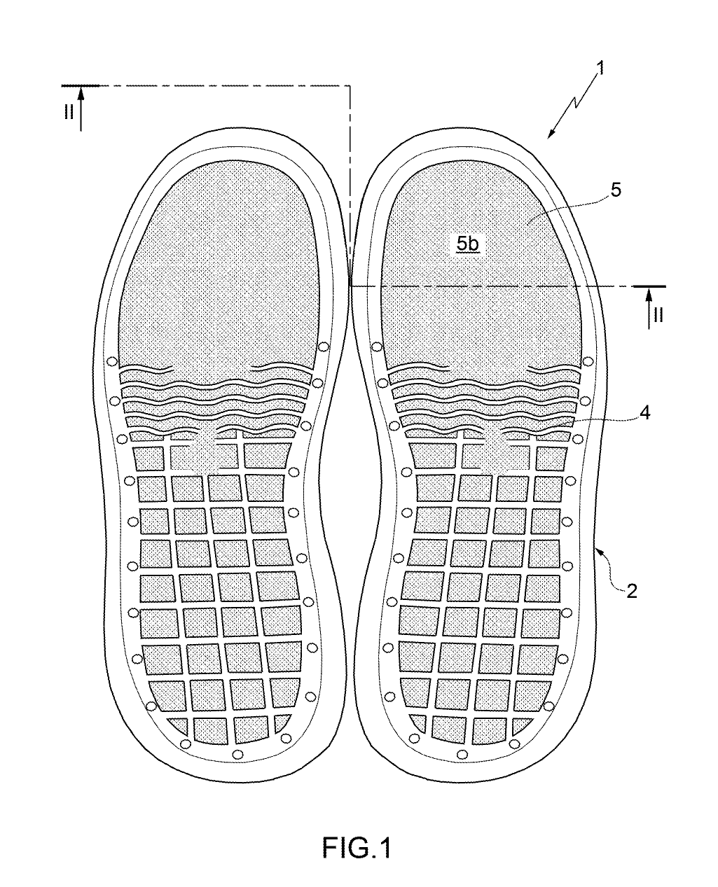

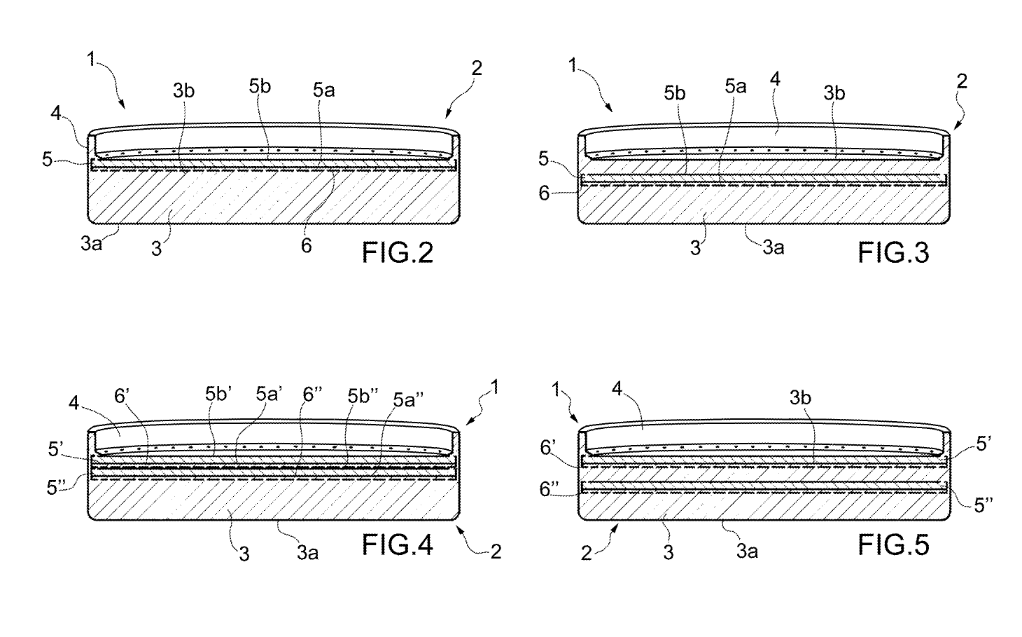

With reference to FIGS. 1 and 2, it will be observed that a footwear sole resistant to perforation according to the present disclosure is generally indicated with the reference number 1 and comprises at least one outer sole 2, including a tread 3 and a perimeter edge 4 rising from the tread. The tread 3 has an outer face 3a provided, in use, for the contact with the ground and an internal face 3b, facing in use the perimeter edge 4.

The outer sole 2, as is typical in the “safety” footwear field, can be made of thermoplastic and/or thermosetting elastomeric material 3, e.g. NBR rubber, whose advantageous characteristics of high abrasion resistance and aging stability are known.

Naturally, other equivalent materials can also be used, for example other types of thermoplastic rubbers. The sole according to the present disclosure also comprises at least one layer 5 of textile fiber material resistant to perforation, incorporated, as will be stated more clearly hereinbelow, in the tread 3 of the outer sole 2.

The layer 5 of material resistant to perforation is a multilayer textile fiber material capable of resisting to accidental perforations by nails or other pointed objects, even with very limited diameter, and complies with the standards provided by the field regulations, in particular UNI EN ISO 20344.

According to a currently preferred variant of the present disclosure, the layer 5 of material resistant to perforation is the product commercially termed L-Protection®, sold by the company LENZI EGISTO S.p.A.

The man skilled in the art will nevertheless understand that any other textile fiber material having physical-mechanical characteristics equivalent thereto will be suitable for being employed in the footwear sole according to the disclosure. With reference to the enclosed FIG. 2, in which only one layer 5 of textile fiber material resistant to perforation is depicted, it will be observed that such layer 5 has a plan configuration substantially corresponding to the plan configuration of the sole and has a face 5a, lower in use, facing the outer face 3a of the tread 3, and a face 5b, upper in use, facing the opposite side, or in other words towards the perimeter edge 4 rising from the tread. The outer sole 2 and the layer 5 of textile fiber material resistant to perforation are engaged with each other by molding the outer sole 2 on or around the layer 5, so as be chemically bonded without interruption to form a single body.

More particularly, the molecules chains of the textile fibers of the layer 5 resistant to perforation are bonded to those of the elastomeric material of the outer sole 2 by means of a curing process, which will be discussed hereinbelow.

For such purpose, the face 5a, lower in use, of the layer 5 of textile fiber material resistant to perforation can be at least partly covered by an auxiliary layer 6 of thermoplastic and/or thermosetting elastomeric material, intended to be bonded without interruption, in the above-described sense, to the elastomeric material of the outer sole during the manufacturing process thereof, thus facilitating an irreversible engagement between the outer sole 2 and the layer 5 made of perforation-resistant material.

The abovementioned auxiliary layer 6 of elastomeric material advantageously prevents possible lateral movements of the textile fibers of the layer 5, thus facilitating a greater resistance to perforation by pointed objects. The auxiliary layer is provided applied in any suitable manner on one or both faces 5a, 5b of the layer 5, without however penetrating inside the layer itself, thus maintaining good flexibility thereof and consequently a good level of comfort for the operator.

If desired, the auxiliary layer 6 and the outer sole 2 can be obtained with the same thermoplastic and/or thermosetting elastomeric material.

The footwear sole according to the present disclosure comprises the layer 5 of textile fiber material resistant to perforation provided, for example, at the top of the tread 3 (FIG. 2). In this manner, it also acts as an inter-sole for a shoe, above which it is possible, if desired, to apply an insole or arch support.

According to a variant of the footwear sole according to the present disclosure (see FIG. 3), the layer 5 of textile fiber material resistant to perforation is provided at an intermediate portion of the tread 3 and is therefore completely embedded or incorporated in the sole itself. In this case, above all if the sole provides for, at the heel, a configuration with lightening cavity (e.g. as represented in FIG. 1), the shoe employing one such sole must comprise an inter-sole supported at the top of the outer sole 2.

According to further variants of the footwear sole according to the present disclosure, a plurality of layers (5′, 5″, etc.) of textile fiber material resistant to perforation (two in FIGS. 4 and 5) are provided for, overlapped in contact with each other. Optionally, each of such layers 5′, 5″ will have at least one face (5a′ or 5b′, 5a″ or 5b″) at least partly covered by an auxiliary layer 6′, 6″ of thermoplastic and/or thermosetting elastomeric material. Such face can be the one that is lower in use 5a′, 5a″, etc., or it can be the one that is upper in use (5b′, 5b″, etc.). In such a manner, during the manufacturing process that will be described hereinbelow, the layers 5′, 5″, etc. will be more easily fixable to each other and to the outer sole 2.

If desired, between one layer (5′) and the other (5″), the sole according to the present disclosure comprises a layer or, in any case, a certain quantity of the elastomeric material employed for the outer sole 2 (see in particular FIG. 5).

The footwear sole resistant to perforation according to the present disclosure is made in a simple and effective manner.

The method of manufacturing thereof comprises an initial step of arranging a mold of conventional type, provided for obtaining soles for “safety” footwear. On the bottom of the mold, provision is made for introducing at least a certain quantity of uncured elastomeric material of the type suitable for obtaining the outer sole 2. As is known, such uncured elastomeric material, at the initial work conditions, is ductile and therefore deformable under the effect of a suitable pressure and temperature.

The method then provides for inserting in the mold, above the quantity of uncured elastomeric material, at least one layer 5 of textile fiber material resistant to perforation.

As stated above, such layer can have one or both faces thereof—lower in use and/or upper in use (5a, 5b)—at least partly covered with a layer of auxiliary material 6 of elastomeric type, of a type seemingly identical but in fact quite different from that employed for obtaining the tread, in any case suitable for being molded together with the elastomeric material of the sole.

According to a first variant of the method for manufacturing a footwear sole according to the present disclosure, provision is then made for a step of closing the mold and applying, in the mold itself, a certain pressure and a certain temperature, thus obtaining the molding of the sole itself.

In the mold, the uncured elastomeric material hardens due to the vulcanization on or around the layer 5 of textile fiber material resistant to perforation, thus obtaining a footwear sole provided with an outer sole 2 and at least one layer 5 of textile fiber material resistant to perforation, chemically bonded together without interruption to form a single body.

If it is intended to obtain a footwear sole comprising only one layer of material resistant to perforation, provided at intermediate position in the tread 3, before the step of closing the mold, provision is made for a step of inserting—in any suitable manner, above the layer 5 in textile fiber material resistant to perforation—an additional quantity of uncured elastomeric material employed for the outer sole 2. If the sole to be obtained comprises a plurality of layers of material resistant to perforation 5, they will be inserted in the mold overlapped on each other or by means of interposition of a certain additional quantity of uncured elastomeric material employed for the outer sole 2.

As will be understood, a “safety” footwear sole manufactured according to the above-described method, has the advantage of being flexible and light, as well highly resistant to perforation by pointed objects. Additionally, the fact that the layer 5 of material resistant to perforation has a plan configuration substantially corresponding to the plan configuration of the footwear sole allows providing greater protection to the foot with respect to the conventional “safety” footwear. The footwear sole that is resistant to perforation as well as the method of manufacturing the same, described above, are susceptible to numerous modifications and variants.

Thus, for example, the above-described method can be executed according to the above-described sequence or provision can be made to initially insert, in the mold, the layer(s) 5, 5′, 5″, etc. of textile fiber material resistant to perforation, supported in the mold in accordance with requirements in any suitable manner, and to subsequently add the uncured elastomeric material before closing the mold itself.

1. A sole for footwear comprising:
at least one outer sole in elastomeric material comprising a tread and a perimeter edge rising from said tread, said tread comprising an outer face; and
at least one layer of textile fibre material resistant to perforation having a lower face facing said outer face of said tread, and an upper face facing said perimeter edge; and wherein
said at least one outer sole and said at least one layer of said textile fibre material resistant to perforation are engaged by moulding said at least one outer sole on or around said at least one layer of said textile fibre material resistant to perforation.

2. The sole according to claim 1, wherein said at least one layer of said at least one textile fibre material resistant to perforation has at least one auxiliary layer of elastomeric material at at least one of the respective faces.

3. The sole according to claim 2, wherein said elastomeric material of said at least one auxiliary layer comprises said elastomeric material of said outer sole.

4. The sole according to claim 1, wherein said at least one layer of textile fibre material resistant to perforation is provided at the top of said tread.

5. The sole according to claim 1, wherein said at least one layer of textile fibre material resistant to perforation is provided in an intermediate area of said tread.

6. The sole according to claim 1 further comprising a plurality of layers in textile fibre material resistant to perforation, said plurality of layers overlapping one another in said tread.

7. The sole according to claim 1 further comprising a plurality of layers in textile fibre material resistant to perforation, said plurality of layers overlapping one another in said tread with interposition of said elastomeric material of said at least one outer sole.

8. The sole according to claim 1, wherein said elastomeric material comprises styrene-butadiene.

9. A method of manufacturing a sole for footwear comprising the following steps:
arranging at least one mould adapted to moulding said outer sole,
introducing into said mould at least one certain quantity of uncured elastomeric material for said outer sole,
arranging above said quantity of uncured elastomeric material at least one layer of textile fibre material resistant to perforation,
closing said mould, and
applying to said mould a sufficient pressure and a temperature to cause the moulding of said uncured elastomeric material on or around said at least one layer.

10. The method according to claim 9, wherein between said step of arranging above said quantity of uncured elastomeric material at least one layer of textile fibre material resistant to perforation and said step of closing said mould, at least one step of applying at least one additional quantity of said uncured elastomeric material on said at least one layer of textile fibre material is provided.

11. The method according to claim 9, wherein said step of arranging above said quantity of uncured elastomeric material at least one layer of textile fibre material resistant to perforation comprises a step of arranging a plurality of layers overlapping one another.

12. The method according to claim 11, wherein said layers of textile fibre material resistant to perforation are overlapping with interposition of an additional quantity of said uncured elastomeric material.

13. Footwear comprising a sole according to claim 1.

14. Footwear manufactured with a method according to claim 9.
